(19) United States
(12) Patent Application Publication
(10) Pub. No.: US 2009/0134731 A1
(43) Pub. Date: May 28, 2009

(54) MAGNET TYPE SYNCHRONOUS MACHINE

(75) Inventors: Kazushige Okumoto, Kariya-shi (JP); Shin Kusase, Oobu-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/275,513

(22) Filed: Nov. 21, 2008

(30) Foreign Application Priority Data
Nov. 26, 2007 (JP) 2007-304263

(51) Int. Cl. H02K 21/12

(52) U.S. Cl. 310/156.38

(57) ABSTRACT

In a SPM synchronous motor has a rotor and a stator, a permanent magnet is divided to magnet parts magnetized in a diameter direction of the rotor and serve as rotor magnetic poles. The rotor magnetic poles are alternately arranged along a circumferential direction of the rotor. The rotor core has a plurality of salient poles made of soft magnetic material. Each salient pole projects from the circumferential surface of the rotor core toward a gap between the rotor and the stator, and is placed at a central part of the corresponding magnet part in the circumferential direction. This structure increases a magnitude of a d-axis inductance Ld and enhances the effects obtained by performing a weakening magnetic flux control using a negative d-axis current Id during a high speed rotation of the motor within a power source voltage limiting range.

### CROSS-REFERENCE TO RELATED APPLICATION

This application is related to and claims priority from Japanese Patent Application No. 2007-304263 filed on Nov. 26, 2007, the contents of which are hereby incorporated by reference.

### BACKGROUND OF THE INVENTION

1. Field of the Invention

The present invention relates to a magnet type synchronous machine, such as a permanent magnet synchronous motor with an improved rotor configuration capable of reducing a magnetic flux during a high speed rotation.

2. Description of the Related Art

There are well-known magnet type synchronous motors such as surface permanent magnet (SPM) synchronous motors and interior permanent magnet (IPM) synchronous motors.

Conventional techniques have proposed various types of the IPM synchronous motors in which permanent magnets are embedded in a rotor core made of a soft magnetic material. For example, a conventional IPM synchronous motor has a configuration in which a pair of permanent magnets is magnetized with the same magnet pole in a diameter direction and placed in a circumferential direction to make a single rotor magnet pole. A rotor core has a magnetic path in a d-axis formed between a pair of permanent magnets.

On the other hand, the conventional SPM synchronous motors are divided into two types. One type of the conventional SPM synchronous motors has a configuration in which the permanent magnets are alternately fixed with a different pole every electric angle Π, and a non-magnetized area or a soft magnetized area (serving as a q-axis salient pole) is placed between adjacent permanent magnets. The other type has a cylindrical shaped permanent magnet which is fitted to a surface of a rotor core made of soft magnetized material. For example, Japanese patent laid open publication No. JP 2005-20876 has disclosed the latter type of the SPM synchronous motor.

When the magnet type synchronous motor works at a high rotational speed, a magnetic flux forces a stator coil to generate a counter electromotive force (or a back electromotive force). This makes a necessity to apply a very high power-source voltage to the stator coil in order to obtain an electrical torque which the magnet type synchronous motor needs.

In order to solve the above drawback, the conventional magnet type synchronous motor performs a weakening magnetic flux control to weaken the magnetic flux by applying a negative (−) d-axis current to the stator coil in order to form a d-axis current magnetic flux φid in a direction to reduce the magnetic flux Φm. This control can decrease the total amount of the magnetic flux.

However, the conventional SPM synchronous motors have permanent magnets with a substantial absolute permeability of vacuum which are placed in d-axis magnetic flux paths. Because this structure makes a small amount of a d-axis inductance Ld, it is necessary to supply or flow a large amount of the negative (−) d-axis current Id in order to effectively decrease the magnetic flux Φm. However, because taking a rapid increase of the negative (−) d axis current invites the voltage of an electric power source and a power loss to increase, it is difficult to adopt such a conventional solution.

### SUMMARY OF THE INVENTION

It is an object of the present invention to provide a magnet type synchronous machine with an improved control capability to weaken a magnetic flux during a high speed rotation of a rotor.

To achieve the above purpose, the present invention provides a magnet type synchronous machine having a rotor and a stator. The rotor has a rotor core and a permanent magnet fixed to a circumferential surface of the rotor core. The stator has a stator core, facing the circumferential surface of the rotor core with a gap. The stator core has slots on which a stator coil is wound. In particular, the permanent magnet is divided to a plurality of magnet parts, the magnet parts are magnetized in a diameter direction of the rotor and serve as rotor magnetic poles (or rotor poles for short) so that the rotor magnetic poles of a different pole are alternately arranged along a circumferential direction of the rotor. In addition, the rotor core has a plurality of salient poles made of soft magnetic material. Each salient pole projects from the circumferential surface of the rotor core toward the gap, and is placed at a central part of the corresponding magnet part as the rotor magnetic pole in the circumferential direction of the permanent magnet.

In the structure of the rotor in the SPM synchronous machine according to the present invention, each magnet part, which serves as the rotor magnet pole, has a thin part forming a concave part or has a through hole. Each salient pole which projects toward the stator is fitted to the concave part, namely, to the thin part of the permanent magnet. The structure of each salient pole in the rotor core makes it possible to increase the d-axis inductance Ld. It is thereby possible to perform the weakening magnetic flux control without increasing any electric power-source voltage and with a small amount of the negative (−) d-axis current, where the weakening magnetic flux control increase a negative (−) d-axis current magnetic flux φid by a negative (−) d-axis current Id at a high speed rotation of the rotor, and decreases a synthesized d-axis magnetic flux (which is a sum of the magnetic flux φm and the d-axis current magnetic flux φid).

### BRIEF DESCRIPTION OF THE DRAWINGS

A preferred, non-limiting embodiment of the present invention will be described by way of example with reference to the accompanying drawings, in which:

FIG. 1 is a schematic cross section of a SPM synchronous motor in its radial direction according to a first embodiment of the present invention;

FIG. 2 is a schematic cross section in a diameter direction of a SPM synchronous motor according to a second embodiment of the present invention;

FIG. 3 is a schematic cross section in a diameter direction of a SPM synchronous motor according to a third embodiment of the present invention;

FIG. 4 is a schematic cross section in a diameter direction of a rotor core without any salient pole in a conventional SPM synchronous motor;

FIG. 5 shows a simulation result of Torque-Rotation speed characteristics of the SPM synchronous motors shown in FIG. 1 and FIG. 4; and

FIG. 6 shows a simulation result of Torque-Rotation speed characteristics of the SPM synchronous motors shown in FIG. 3 and FIG. 4.

### DETAILED DESCRIPTION OF THE PREFERRED EMBODIMENTS

Hereinafter, various embodiments of the SPM synchronous motors according to the present invention will be described with reference to the accompanying drawings. In the following description of the various embodiments, like reference characters or numerals designate like or equivalent component parts throughout the several diagrams. Although the following embodiments will explain a magnet type synchronous machine such as a SPM synchronous motor having an inner rotor structure, the concept of the present invention can be applied to various types of the machines such as magnet type synchronous machine having an outer rotor structure without difficulty.

### First Embodiment

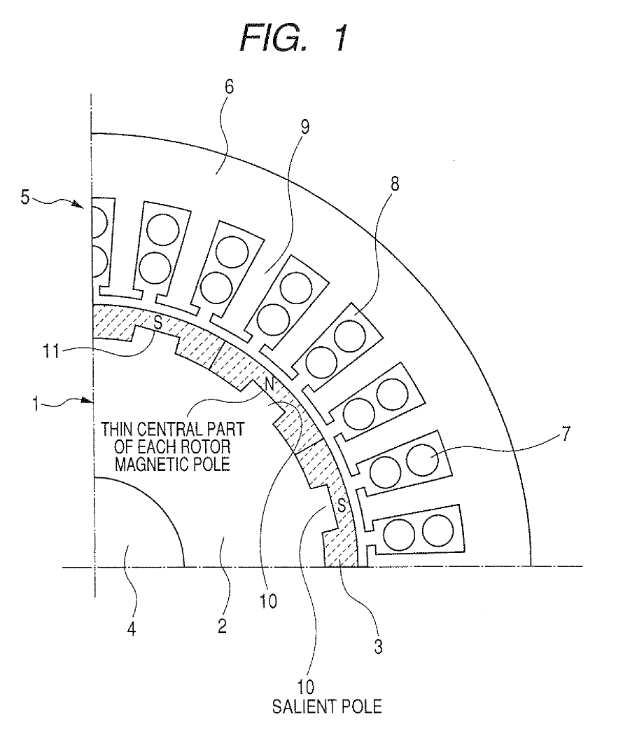

A description will be given of various embodiments of the surface permanent magnet (SPM) synchronous machine (hereinafter, referred to as the “SPM synchronous motor”) according to the first embodiment with reference to FIG. 1 to FIG. 6.

FIG. 1 is a schematic cross section (as one quarter part) in a diameter direction of the SPM synchronous motor according to the first embodiment of the present invention. Hatching is omitted from FIG. 1.

### Entire Structure

As shown in FIG. 1, the SPM synchronous motor is comprised mainly of a rotor 1, a rotor core 2, a permanent magnet 3 of a cylindrical shape, a rotary shaft 4, a stator 5, a stator core 6, and stator coils 7.

The permanent magnet 3 of a cylindrical shape will also be referred to as the “cylindrical permanent magnet 3” for short. The cylindrical permanent magnet 3 is divided into twelve magnet parts. The twelve magnet parts act as rotor magnetic poles which will be explained.

The stator 5 is composed mainly of the stator core 6 made of laminated magnetic-steel sheets and the stator coils 7 which are wound on slots 8 formed in the stator core 6. The stator 5 of the SPM synchronous motor according to the present invention is similar in configuration to that of a conventional SPM synchronous motor. The stator core 6 is fixed to an inner circumferential surface of a housing (not shown). The stator core 6 has teeth 9. Each tooth 9 projects toward the inside along the diameter direction of the stator 5, namely, toward the rotor 1 comprised of the permanent magnet 3 and the rotor core 2 with salient poles 10. These salient poles 10 will be explained later in detail.

The rotor core 2 is made generally of soft magnetic material. The rotor core 2 is fixedly fitted to the rotary shaft 4. The rotary shaft 4 is rotatably supported by the housing.

The permanent magnet 3 has a cylindrical shape and is fixed to the outer circumferential surface of the rotor core 2. The rotor 1 has twelve rotor magnetic poles. The cylindrical permanent magnet 3 is placed on the outer circumferential surface of the rotor core 2. Each part of the cylindrical permanent magnet 3 which corresponds to each rotor magnetic pole (per 30 degrees in the circumferential direction of the rotor core 2) is magnetized with a different pole along the diameter direction. In other words, a pair of adjacent parts in the cylindrical permanent magnet 3 has a different magnetic pole (North (N) pole and South (S) pole).

Through the description, the part of the same magnetic pole (N or S) in the cylindrical permanent magnet 3 within 30 degrees along the circumferential direction will be call to as the “rotor magnetic pole”.

Other components and actions thereof in the SPM synchronous motor according to the first embodiment are same as those in the conventional SPM synchronous motor. The explanation of the same components and actions are omitted here.

### Salient Poles 10

A plurality of the salient poles 10 are formed on the outer circumferential surface of the rotor core 2. Each salient pole 10 is formed in the circumference direction of the rotor core 2 at a central part of its corresponding rotor magnetic pole. The salient poles 10 are made of soft magnetic material. The rotor core 2 and the salient poles 10 are formed integrally.

In the embodiments according to the present invention, each salient pole 10 has: a height within a range of 50 to 80% of a thickness in the diameter direction of the permanent magnet 3; a width within a range of 30 to 70% of a circumferential occupied width (30 degrees in the embodiments) in the circumferential direction of the rotor magnetic pole; and a length which is same, in the axial direction, as that of each of the permanent magnet 3 and the rotor core 2.

The present invention is not limited by the above structure of the salient poles 10. It is possible to change the height, width, and length of the salient poles 10 according to applications.

In the first embodiment, concave parts 11 are formed in the inner circumferential surface of the cylindrical permanent magnet 3. Each salient pole 10 corresponds to each concave part 11. That is, each salient pole 10 is inserted and fixed to the corresponding concave part 11.

### Effects

In the improved structure of the SPM synchronous motor according to the first embodiment, the central part along the circumferential direction of each rotor magnetic pole in the cylindrical permanent magnet 3 is thinner than its remaining part in the diameter direction. This thin central part of each rotor magnet pole increases a d-axis inductance Ld, and decreases a d-axis magnetic resistance.

When the SPM synchronous motor performs the weakening magnetic-flux control when the rotor rotates at a high speed, the structure of each rotor magnetic pole with the thin central part in the cylindrical permanent magnet 3 avoids any increasing a negative (−) d-axis current Id by the increased amount of the d-axis inductance Ld, where the weakening magnetic-flux control increases the d-axis current magnetic flux Φid in a negative direction (which is counter to the direction of the magnetic-flux Φm), and decreases the entire d-axis magnetic flux Φd (=the magnetic flux Φm−d-axis current magnetic flux Φid).

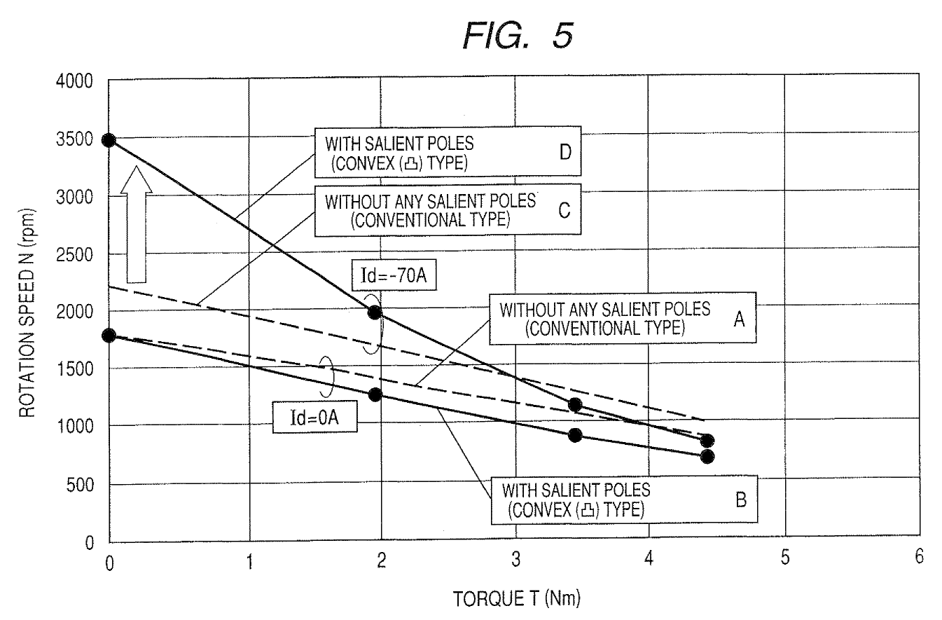

In other words, the improved rotor structure of the SPM synchronous motor according to the first embodiment has a superior effect of the weakening magnetic flux control within the power source voltage limiting range. This effect of the SPM synchronous motor according to the first embodiment will now be explained by the simulation result shown in FIG. 5.

FIG. 5 shows the simulation result of Torque-Rotation speed characteristics of the SPM synchronous motors according to the first embodiment shown in FIG. 1.

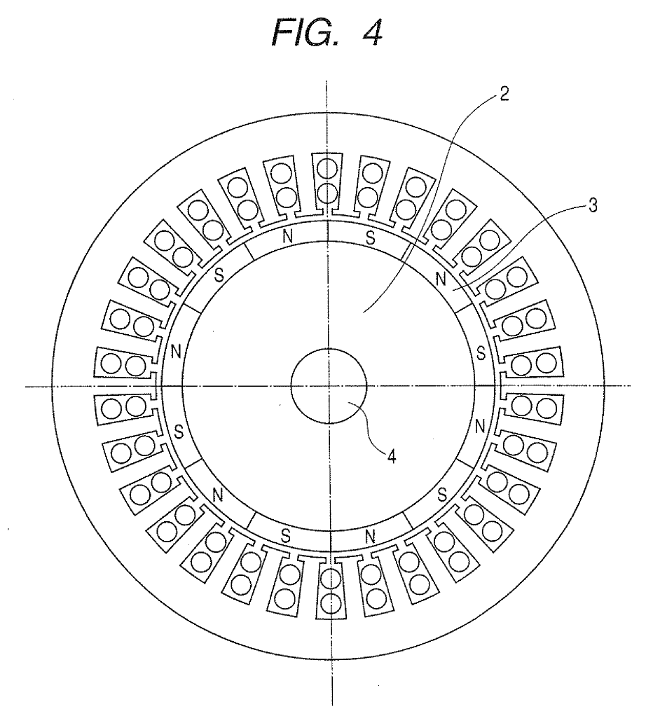

FIG. 5 shows the characteristics of Torque-Rotation speed of the rotor core 2 having the salient poles 10 in the SPM synchronous motor according to the first embodiment. FIG. 5 also shows the simulation result of the characteristics of a torque-rotation speed of a conventional rotor core without any salient pole. FIG. 4 shows a schematic structure of such a conventional rotor core without any salient pole.

In FIG. 5, reference character A designates the torque-rotation speed characteristic line of a conventional rotor core without any salient pole when no negative (−) d-axis current Id flows. Reference character B designates the torque-rotation speed characteristic line of the rotor core with the salient poles 10 when no negative (−) d-axis current Id flows. Reference character C designates the torque-rotation speed characteristic line of the conventional rotor core without any salient pole when a negative (−) d-axis current Id of −70A flows. Reference character D designates the torque-rotation speed characteristic line of the rotor core with the salient poles 10 when a negative (−) d-axis current Id of −70A flows.

This simulation used the SPM synchronous motor according to the first embodiment in which the permanent magnet 3 has a thickness of 3 mm, the rotor 1 has an outer diameter of φ45 mm, the permanent magnet 3 is made of sintered neodymium magnet, and each salient pole 10 has a circumferential width of 5 mm in the circumferential direction (corresponding to a circumferential occupied angle of 12.7 degrees). Other components of the SPM synchronous motor according to the present invention are same as those of the conventional SPM synchronous motor.

FIG. 1 relating to the first embodiment and FIG. 4 relating to the conventional case show the SPM synchronous motors which have the twelve poles and thirty slots. On the other hand, FIG. 5 shows the simulation results of the SPM synchronous motors having ten poles and sixty slots.

As can be understood from the simulation result shown in FIG. 5, when the weakening magnetic flux control is performed using the same electric power source, the SPM synchronous motor with the salient poles 10 according to the present invention designated by reference character D can generate the electrical torque until the motor reaches a high speed rotation. That is, the capability of the SPM synchronous motor is drastically improved when compared with the conventional case designated by reference character C. This means that the SPM synchronous motor with the salient poles 10 according to the present invention can efficiently decrease the synthesized d-axis magnetic flux by the negative (−) d-axis currents Id of the same magnitude. This can suppress the stator coil from generating a counter electromotive force (or a back electromotive force), and can thereby maintain the q-axis current Iq as the torque current component.

### Second Embodiment

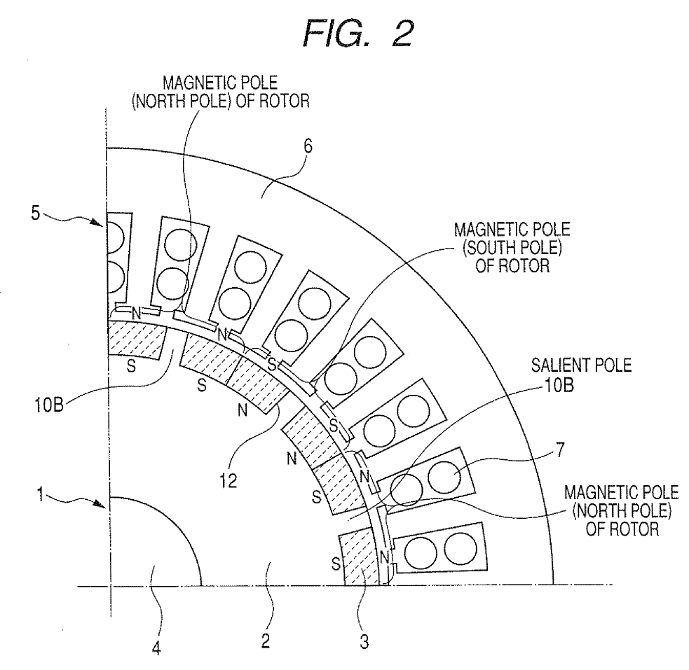

A description will be given of the SPM synchronous motor according to the second embodiment of the present invention with reference to FIG. 2.

FIG. 2 is a schematic cross section (as one quarter part) in a diameter direction of the SPM synchronous motor according to the second embodiment of the present invention. Hatching is omitted from FIG. 2.

As shown in FIG. 2, each salient pole 10B is exposed (or reaches) to the gap formed between the outer surface of the rotor 1 of the SPM synchronous motor and the inner peripheral surface of the stator core 6 according to the second embodiment. That is, each salient pole 10B reaches the outside surface of the rotor 1 through a corresponding through hole 12 formed in the cylindrical permanent magnet 3. The cylindrical permanent magnet 3 has the through holes 12, instead of the concave parts 11, which correspond to the salient poles 10B. It is also possible to place a pair of permanent magnet pieces of the same magnetic pole, instead of the through holes 12, at both sides of each salient pole 10B to form one rotor magnetic pole.

When compared with the structure of the rotor shown in FIG. 1, the structure of the rotor shown in FIG. 2 makes it possible to further increase the effect obtained by the weakening magnetic flux control, because of drastically increasing the d-axis inductance Ld (namely, decreasing the d-axis magnetic resistance).

### Third Embodiment

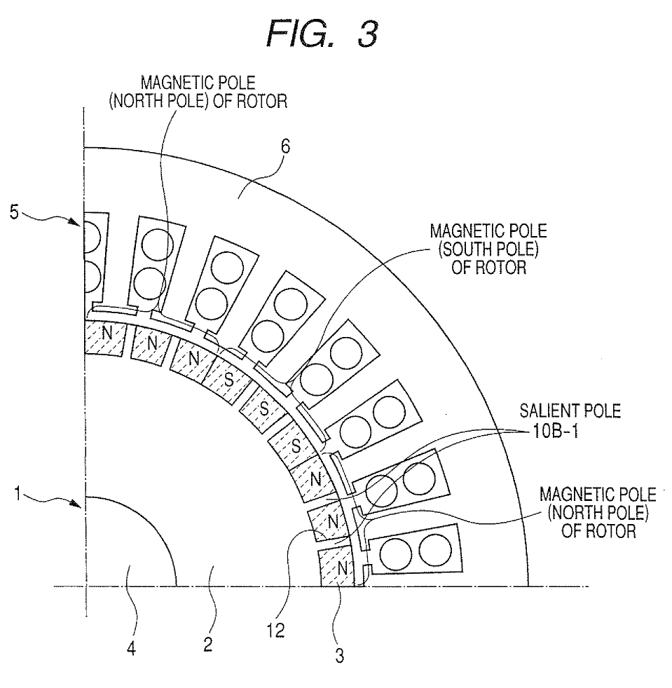

A description will be given of the SPM synchronous motor according to the third embodiment of the present invention with reference to FIG. 3.

FIG. 3 is a schematic cross section (as one quarter part) in a diameter direction of the SPM synchronous motor according to the third embodiment of the present invention. Hatching is omitted from FIG. 3.

In the structure of the rotor 1 shown in FIG. 3, a pair of the salient poles 10B-1 is placed per rotor magnetic pole. The pair of salient pole 10B-1 shown in FIG. 3 corresponds to each salient pole 10B shown in FIG. 2. In particular, the circumferential width of each pair of salient poles 10B-1 in the rotor 3 of the SPM synchronous motor according to the third embodiment is a half of the circumferential with of each salient pole 10B shown in FIG. 2.

Because the entire width of the pair of adjacent salient poles 10B-1 takes a selectable value, it is possible to form the pair of adjacent salient poles 10B-1 with approximately the same circumferential width as each salient pole 10B shown in FIG. 2.

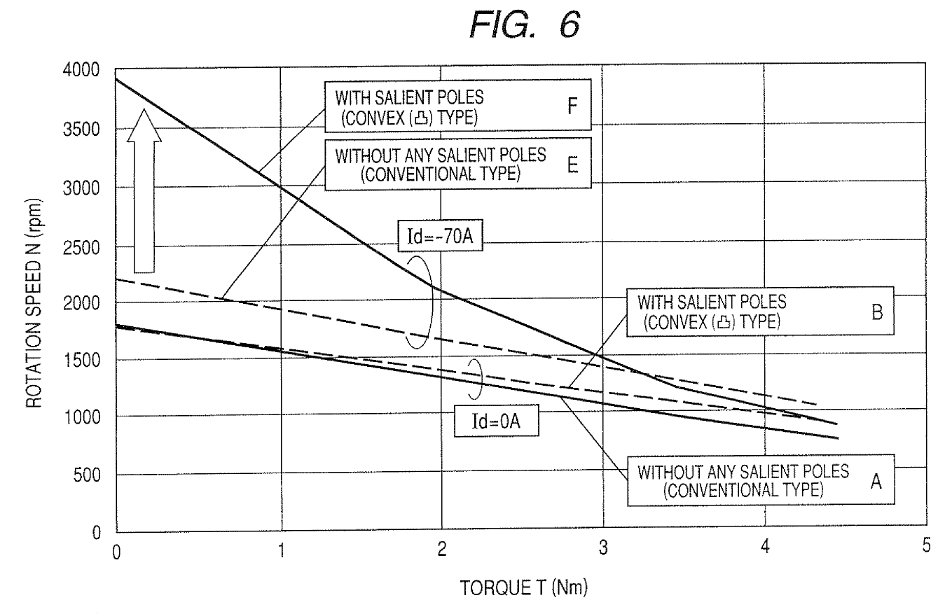

FIG. 6 shows a simulation result of Torque-Rotation speed characteristics of the SPM synchronous motors having the salient poles 10B-1 shown in FIG. 3. Like the simulation result shown in FIG. 5, FIG. 6 also shows the characteristics of Torque-Rotation speed of the rotor core without any salient pole in the conventional SPM synchronous motors.

In FIG. 6, reference character E designates the torque-rotation speed characteristic line of the conventional rotor core without any salient pole when a negative (−) d-axis current Id of −70A flows. Reference character F designates the torque - rotation speed characteristic line of the rotor core with the salient poles 10B-1 when a negative (−) d-axis current Id of −70A flows.

Reference characters A and B shown in FIG. 6 are the same as those shown in FIG. 5. That is, reference character A designates the torque-rotation speed characteristic line of a conventional rotor core without any salient pole when no negative (−) d-axis current Id flows. Reference character B designates the torque-rotation speed characteristic line of the rotor core with the salient poles 10B-1 when no negative (−) d-axis current Id flows.

This simulation used the SPM synchronous motor according to the third embodiment in which the salient poles 10B-1 reach the electromagnetic gap. The permanent magnet 3 has a thickness of 3 mm, the rotor 1 has an outer diameter of φ45 mm, the permanent magnet is made of sintered neodymium magnet, and each salient pole 10B-1 has a circumferential width of 1 mm in the circumferential direction. Other components of the SPM synchronous motor according to the present invention are same as those of the conventional SPM synchronous motor.

Although FIG. 3 relating to the third embodiment and FIG. 4 relating to the conventional case show the SPM synchronous motors having the twelve poles and thirty slots, FIG. 6 shows the simulation result of the SPM synchronous motors having ten poles and sixty slots.

The structure of the rotor in the SPM synchronous motors according to the third embodiment has the same effect of the weakening magnetic control in the rotor in the SPM synchronous motors according to the second embodiment. In addition, the structure of the rotor in the SPM synchronous motors according to the third embodiment reduces a rapid change of the magnetic flux distribution in the circumferential direction of the electromagnetic gap which is formed between the outer peripheral surface of the rotor 1 and the inner peripheral surface of the stator 5. This can thereby reduce the torque ripple in the SPM synchronous motor.

The SPM synchronous motors according to the third embodiment has another structure in which each salient pole 10B-1, the rotor core 2, and the permanent magnet 3 have the same length in the axial direction, or has another structure in which each salient pole 10B-1 is shorter in length in the axial direction than the rotor core 2 and the permanent magnet 3, and the through holes are formed in the permanent magnet 3, into which the salient poles 10B-1 are inserted and fitted.

### Other Features and Effects of the Present Invention

In the magnet type synchronous motor as another aspect of the present invention, a part of each magnet part in the permanent magnet, which is contacted to the corresponding salient pole, is thinner in the diameter direction than the remaining part thereof.

Because this structure makes it possible to increase an inductance of the d-axis magnetic path which passes through the salient pole, it is possible to increase the effect obtained by the weakening magnetic flux control.

In the magnet type synchronous motor as another aspect of the present invention, the permanent magnet has a plurality of through holes. Each through hole is formed in the diameter direction of the rotor core so that the corresponding salient pole is inserted and fixed in the through hole.

Because this structure of the rotor core has no permanent magnet having a relative permeability of 1 in the d-axis magnetic path which passes through the salient pole, it is possible to greatly increase the d-axis inductance. Accordingly, this structure makes it possible to increase the effect of the weakening magnetic flux control.

In the magnet type synchronous motor as another aspect of the present invention, each magnet part forming the rotor magnetic pole is made of two permanent-magnet pieces which are adjacent in the circumferential direction of the rotor core and placed at both sides of the corresponding salient pole.

Because this structure enables the salient poles in the entire of the axial direction of the rotor to be formed, it is possible to increase the effect of the d-axis inductance Ld which is additionally obtained by the formation of the salient poles.

In the magnet type synchronous motor as another aspect of the present invention, each salient pole is formed at a central part of the corresponding magnet part as the rotor magnetic pole in the circumferential direction of the rotor core.

This structure makes it possible to efficiently generate the d-axis current magnetic flux φid in a counter direction to the magnetic flux φm.

In the magnet type synchronous motor as another aspect of the present invention, the salient poles are placed every a predetermined interval along the circumferential direction of the rotor core.

This structure makes it possible to decrease an unbalanced magnetic-flux distribution along the circumferential surface of the rotor, and thereby possible to decrease a torque ripple of the magnet type synchronous motor.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. A magnet type synchronous machine comprising:
a rotor comprising a rotor core and a permanent magnet fixed to a circumferential surface of the rotor core; and
a stator comprising a stator core, facing the circumferential surface of the rotor core with a gap, comprising slots on which a stator coil is wound,
wherein the permanent magnet is divided to a plurality of magnet parts, the magnet parts are magnetized in a diameter direction of the rotor and serve as rotor magnetic poles so that the rotor magnetic poles of a different magnetic pole are alternately arranged along a circumferential direction of the rotor, and
the rotor core has a plurality of salient poles made of soft magnetic material, each salient pole projecting from the circumferential surface of the rotor core toward the gap, and each salient pole being placed at a central part of the corresponding magnet part as the rotor magnetic pole in the circumferential direction of the permanent magnet.

2. The magnet type synchronous machine according to claim 1, wherein a part of each magnet part in the permanent magnet, which is contacted to the corresponding salient pole, is thinner in the diameter direction than the remaining part thereof.

3. The magnet type synchronous machine according to claim 1, wherein the permanent magnet has a plurality of through holes, and each through hole is formed in the diameter direction of the rotor core so that the corresponding salient pole is inserted and fixed in the through hole.

4. The magnet type synchronous machine according to claim 1, wherein each magnet part forming the rotor magnetic pole is made of two permanent-magnet pieces which are adjacent in the circumferential direction of the rotor core and placed at both sides of the corresponding salient pole.

5. The magnet type synchronous machine according to claim 3, wherein each salient pole is formed at a central part of the corresponding magnet part as the rotor magnetic pole in the circumferential direction of the rotor core.

6. The magnet type synchronous machine according to claim 4, wherein each salient pole is formed at a central part of the corresponding magnet part as the rotor magnetic pole in the circumferential direction of the rotor core.

7. The magnet type synchronous machine according to claim 3, wherein the salient poles are placed separated by a predetermined interval along the circumferential direction of the rotor core.

8. The magnet type synchronous machine according to claim 4, wherein the salient poles are placed separated by a predetermined interval along the circumferential direction of the rotor core.
